(19) United States
(12) Patent Application Publication
(10) Pub. No.: US 2007/0201540 A1
(43) Pub. Date: Aug. 30, 2007

(54) Hybrid power line wireless communication network

(76) Inventor: William H. Berkman, New York, NY (US)

Correspondence Address: CAPITAL LEGAL GROUP, LLC, 5323 POOKS HILL ROAD, BETHESDA, MD, 20814, US

(21) Appl. No.: 11/353,080

(22) Filed: Feb. 14, 2006

(51) Int. Cl. H04L 5/16

(52) U.S. Cl. 375/219

(57) ABSTRACT

A hybrid power line wireless communication system may include an access controller and plurality of communication nodes that each may include a wireless access point coupled to a power line communication device. The wireless access points may provide wireless broadband communications to one or more user devices while the power line communication devices may provide low voltage power line broadband communications. The access controller remotely manages the wireless access points by sending control messages to the communication nodes. Control messages may traverse a power line, a non-power line medium, and/or a wireless medium. Control messages may include information relating to encryption parameters, transmission power levels, communication channels, access control, and other such parameters.

### FIELD OF THE INVENTION

The present invention generally relates to communication systems, and more particularly to a hybrid power line wireless communication network.

### BACKGROUND OF THE INVENTION

Reliance on communication networks to deliver data services to customers is increasing. Customers desire communication services to access to voice, video, audio, text, and other types of data whenever they want and wherever they are. In response to these demands, the communication infrastructure is expanding to include many types of communication networks beyond the public switched telephone network. Examples of the increasing infrastructure include power line communication systems and wireless networks.

Power line communication systems use portions of the power system infrastructure to create a communication network. Well-established power distribution systems exist throughout most of the United States, and other countries, for providing power to customers via power lines. With some modification, the infrastructure of the existing power distribution systems can provide data communications in addition to power delivery, thereby forming a power line communication system (PLCS). Specifically, existing power lines that already have been run to and through many homes, buildings and offices, can be used to carry data signals to and from the homes, buildings, and offices. These data signals are communicated on and off the power lines at various points in the power line communication system, such as, for example, near homes, offices, Internet service providers, and the like.

A wireless network typically include wireless access points that include a transceiver which establishes communication links with wireless communication devices. Wireless networks are being created which allow customers to access the global communication network (e.g., the internet) while traveling away from their regular network access area (e.g., their home or office). One challenge of providing a wireless network is connecting the wireless access points to the Internet or other network. Another challenge for wireless networks, especially where the operator desires to cover a large area, is coordinating and controlling the numerous access points.

Whether a customer accesses the internet through a wireless network, a power line communication network, or another type of network, there is a need to control and manage the devices providing the access. Some embodiments of the present invention may address these needs and offer advantages over conventional power line communication systems and wireless networks.

### SUMMARY OF THE INVENTION

The present invention provides a hybrid power line wireless communication system. In one embodiment, a hybrid power line wireless communication system may include an access controller and plurality of communication nodes that each may include a wireless access point coupled to a power line communication device. The wireless access points may provide wireless broadband communications to one or more user devices while the power line communication devices may provide low voltage power line broadband communications. The access controller remotely manages the wireless access points by sending control messages to the communication nodes. Control messages may traverse a power line, a non-power line medium, and/or a wireless medium. Control messages may include information relating to encryption parameters, transmission power levels, communication channels, access control, and other such parameters.

The invention will be better understood by reference to the following detailed description taken in conjunction with the accompanying drawings.

### BRIEF DESCRIPTION OF THE DRAWING

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of a power line communication system formed over a portion of a power system infrastructure;

FIG. 2 is a block diagram of a power line wireless network;

FIG. 3 is a block diagram of an example embodiment of a backhaul node of a power line wireless network according an example implementation of a power line wireless network;

FIG. 4 is a block diagram of an example embodiment of an access node according an example implementation of a power line wireless network;

FIG. 5 depicts an example implementation of an embodiment of an access node according an example implementation of a power line wireless network;

FIG. 6 is a schematic diagram of an example embodiment of a power line wireless network according to the present invention;

FIG. 7 is a block diagram of an example embodiment of a communication node according to an implementation of a power line wireless network;

FIG. 8 is a block diagram of another example embodiment of a communication node according to an implementation of a power line wireless network;

FIG. 9 is a block diagram of yet another example embodiment of a communication node according to an implementation of a power line wireless network;

FIG. 10 is a block diagram of still another example embodiment of a communication node according to an implementation of a power line wireless network;

FIG. 11 is a block diagram of yet another example embodiment of a communication node according to an implementation of a power line wireless network;

FIG. 12 is a block diagram of still another example embodiment of a communication node according to an implementation of a power line wireless network;

FIG. 13 is a block diagram of another example embodiment of a communication node according to an implementation of a power line wireless network; and

FIG. 14 is a schematic diagram of an example embodiment of a power line wireless network according to the present invention.

### DETAILED DESCRIPTION OF ILLUSTRATED EMBODIMENTS

In the following description, for purposes of explanation and not limitation, specific details are set forth, such as particular networks, communication systems, computers, terminals, devices, components, techniques, data and network protocols, software products and systems, enterprise applications, PLCS, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, PLCS, terminals, devices, components, techniques, data and network protocols, software products and systems, operating systems, development interfaces, and hardware are omitted so as not to obscure the description of the present invention.

### System Architecture and General Design Concepts

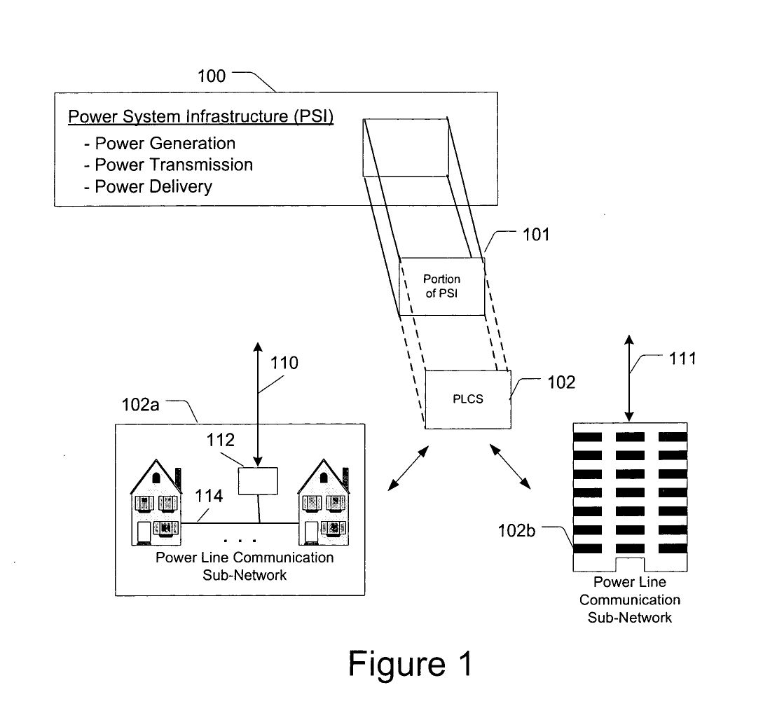

FIG. 1 shows a power line communication system (PLCS) 102 formed using a portion 101 of the power system infrastructure 100. Any of several PLCS embodiments or the like may be implemented, including a residential PLCS 102a, a multi-unit building PLCS 102b, or another PLCS. Some embodiments use only power lines as the communication medium. Other embodiments include some communication links using power lines and other communication links using one or more other media (e.g., wireless, fiber optic, twisted pair, coaxial cable). The term power line communication system is generally used herein to include a communication network that communicates over at least one external power line, and that may include additional communication media, such as a wireless, fiber optic, coaxial cable and/or twisted pair medium. The term power line wireless network, as used herein, includes at least power line and wireless communication media, may include still another type of communication medium, and is an embodiment of a PLCS 102.

The power system infrastructure (PSI) 100, also referred to herein as a power distribution system, includes components for power generation, power transmission, and power delivery. Power is generated at a power generation source, which typically generates power as high as 25 kilo-volts (kV). A transmission substation, typically located near a corresponding power generation source, increases the generated voltage to a desired high voltage for transmission along high voltage (HV) transmission lines. Typical voltages found on HV transmission lines range from 69 kV to in excess of 800 kV.

Switching substations are located along the transmission lines to route high voltage power line transmissions from one portion of the power system infrastructure to another portion. Distribution substations receive the high voltage power line transmissions and reduce the high level power voltages to medium level power voltages. Medium voltage (MV) power lines 110 distribute the medium level power voltages to a region or local area. Typical voltage levels on the MV power lines 110 range from about 1000 V to about 100 kV. FIG. 1 shows MV power lines 110 extending to a residential region hosting a PLCS 102a. FIG. 1 also shows power lines 111 which extend to a multi-unit building hosting a PLCS 102b. The power lines 111 are MV power lines in one embodiment and low voltage power lines in another embodiment.

Customer premises typically are served using low level voltages. To distribute power at low level voltages that are required at customer premises, the MV power lines 110 extend to multiple distribution transformers 112. A distribution transformer 112 steps down the medium level power voltages to the requisite lower level voltages. Low voltage (LV) power lines 114 carry low level power voltages to households, office, building units and other types of premises. Typical voltage levels on LV power lines 114 typically range from about 100 V to about 240 V.

Transformers are used to convert between the respective voltage portions, e.g., between the HV section and the MV section and between the MV section and the LV section. Transformers have a primary side for connection to a first voltage (e.g., the MV section) and a secondary side for outputting another (usually lower) voltage (e.g., the LV section). Transformers, therefore, provide voltage conversion for the power distribution system.

A distribution transformer 112 may function to distribute one, two, three, or more phase power signals to a structure, depending upon the demands of the user. In the United States, for example, these local distribution transformers 112 typically feed anywhere from one to ten homes, depending upon the concentration of the customer premises in a particular area. Distribution transformers may be pole-top transformers located on a utility pole, pad-mounted transformers located on the ground, or transformers located under ground level.

### Power Line Wireless Network

The power line wireless network of the present invention may provide high speed internet access, mobile telephone communications, broadband communications, streaming video and audio services, and other communication services to each home, building or other structure, and to each room, office, apartment, or other unit or sub-unit of multi-unit structure. In addition, the power line wireless network may provide these communication services to mobile and stationary devices in outdoor areas such as customer premises yards, parks, stadiums, and also to public and semi-public indoor areas such as subway trains, subway stations, train stations, airports, restaurants, public and private automobiles, bodies of water (e.g., rivers, bays, inlets, etc.), building lobbies, elevators, etc.

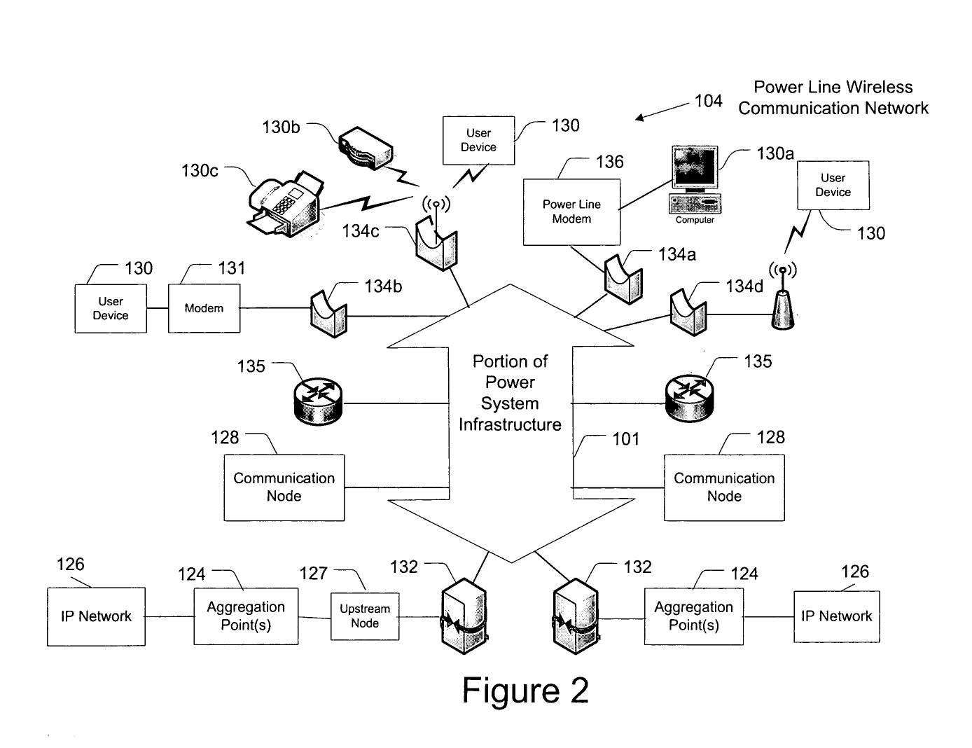

FIG. 2 shows a power line wireless communication network 104 which links user devices 130 to an IP network 126. The power line wireless network 104 includes a plurality of communication nodes 128 which form communication links over a portion 101 of the power system infrastructure. In this example embodiment, one type of communication node 128 is a backhaul node 132. Another type of communication node is an access node 134. Another type of communication node 128 is a repeater node 135. A given communication node 128 may serve as one or more of a backhaul node 132, access node 134, and repeater node 135.

A communication link is formed between two communication nodes over a communication medium. Some links are formed by using a portion 101 of the power system infrastructure. Specifically, some links are formed over MV power lines 110, and other links are formed over LV power lines 114. Still other links may be formed over another communication media, (e.g., a coaxial cable, a T-1 line, a fiber optic cable, wirelessly (e.g., IEEE 802.11 a/bIg, 802.16, 1G, 2G, 3G, or satellite such as WildBlue®)). The power line wireless network 104 of this example includes links formed by power lines and by wireless media, but may also include links formed by additional wired media. The links formed by wired or wireless media may occur at any point along a communication path between a backhaul node 132 and a user device 130.

Each communication node 128 may be formed by one or more communication devices. Communication nodes which communicate over a power line medium include a power line communication device. Exemplary power line communication devices include a backhaul point, a bypass device, and a repeater. Communication nodes which communicate wirelessly include a wireless access point having at least a wireless transceiver. Communication nodes which communicate over a coaxial cable may include a cable modem. Communication nodes which communicate over a twisted pair wire may include a DSL modem or other modem. A given communication node typically will communicate in two directions (either full duplex or half duplex), which may be over the same or different types of communication media. Accordingly, a communication node may include one, two or more communication devices.

A backhaul node 132 serves as an interface between the power line (and is typically coupled to a MV power line is this example embodiment) and an upstream device, which may be, for example, an aggregation point 124 that may provide a connection to the IP network 126. The power line wireless network 104 may include one or more backhaul nodes 132. Upstream communications may be communicated to a backhaul node 132 from within the power line wireless network 104, then transmitted to an aggregation point 124. The backhaul node 132 may be coupled to the aggregation point 124 directly or indirectly (i.e., via one or more intermediate nodes). The backhaul node 132 may communicate with its upstream device via any of several alternative communication media, such as a fiber optic (digital or analog (e.g., Wave Division Multiplexed), coaxial cable, WiMAX, IEEE, 802.11, twisted pair and/or another wired or wireless media. Downstream communications from the IP network 126 typically are communicated through the aggregation point 124 to the backhaul node 132. The aggregation point 124 typically includes an Internet Protocol (IP) network data packet router and is connected to an IP network backbone, thereby providing access to an IP network 126 (i.e., can be connected to or form part of a point of presence or POP). Any available mechanism may be used to link the aggregation point 124 to the POP or other device (e.g., fiber optic conductors, T-carrier, Synchronous Optical Network (SONET), and wireless techniques).

A repeater node 135 may receive and re-transmit data (i.e., repeat), for example, to extend the communications range of other communication elements. As a communication traverses the power line communication network 104, backhaul nodes 132 and access nodes 134 may serve as repeater nodes 135 (e.g., for other access nodes and other backhaul nodes 132). Repeaters 135 may be coupled to and repeat data on MV power lines or LV power lines (and, for the latter, be coupled to the internal or external LV power lines).

An access node 134 may provide communications for one or more user devices 130. Upstream data is transmitted from a user device 130 to an access node 134. The data is routed through the power line wireless network 104 to a backhaul node 132, (or, in some instances, a local destination, such as another user device 130). Downstream data is transmitted through the power line wireless network 104 to a user device 130. Exemplary user devices 130 include a computer 130a, LAN, a WLAN, router 130b, Voice-over IP endpoint, game system, personal digital assistant (PDA), mobile telephone, digital cable box, power meter, gas meter, water meter, security system, alarm system (e.g., fire, smoke, carbon dioxide, security/burglar, etc.), stereo system, television, fax machine 130c, HomePlug residential network, or other device having a data interface. A user device 130 may include, or be coupled to, a modem (not shown) to communicate with a given access node 134. Exemplary modems of this example embodiment include a power line modem or a wireless modem. Other embodiments may additionally or alternately include a cable modem, a DSL modem or other suitable transceiver device.

An access node 134 may couple data between an MV power line and an LV power line; between two MV power lines; between two LV power lines; or between a power line and a non-power line medium. Typically, an access node 134 is couple on one side to a power line (e.g., an MV power line or an LV power line) and on another side to any suitable medium, such as an LV power line, a fiber optic cable, a twisted pair, a wireless medium or another communication medium. Referring to FIG. 2, access node 134a is coupled to a power line modem 136 over a power line. Access node 134b is coupled to a user device 130 over a wired medium (e.g., fiber optic cable). Access nodes 134c and 134d are coupled to user devices 130 wirelessly.

In various embodiments a user device 130 may be coupled to an access node 134 via a modem that is integrated with or separate from the user device 130. For a power line medium, a power line modem 136 may be used. The power line modem 136 may be coupled to, and communicate over, a LV power line. Protocols for communicating over an LV power line, which may be used include the HomePlug 1.0 and A/V standards of the HomePlug® Alliance. On its other port, the power line modem 136 may be connected to a wired medium (or may include a wireless transceiver) to communicate with a user device 130.

For wireless communications a wireless transceiver is used. For purposes of this description, unless otherwise noted, “modem” and “transceiver” are used interchangeably (and includes devices that do not necessarily transmit and receive simultaneously). For a coaxial cable a cable modem is used. For a twisted pair line a DSL modem may be used. The specific type of modem depends on the type of medium linking the access node 134 and user device 130. In this manner, a customer can connect a variety of user devices 130 to the power line wireless network 104.

Communication among nodes 128 may occur using a variety of protocols and media. Thus, the nodes may include a modem that is substantially compatible with the Homeplug 1.0 or A/V standard. In one example, the nodes 128 may use time division multiplexing and implement one or more layers of the 7 layer open systems interconnection (OSI) model. For example, at the layer 3 ‘network’ level, the devices and software may implement switching and routing technologies, and create logical paths, known as virtual circuits, for transmitting data from node to node. Similarly, error handling, congestion control and packet sequencing can be performed at Layer 3. In one example embodiment, Layer 2 ‘data link’ activities include encoding and decoding data packets and handling errors of the ‘physical’ layer 1, along with flow control and frame synchronization. The configuration of the various communication nodes may vary. In various embodiment, the communications among nodes may be time division multiple access or frequency division multiple access.

Some communication nodes 128 (e.g., access nodes 134, smart power line modems 136, and/or backhaul nodes 132) may provide additional communication services for user devices 130 such as security management; IP network protocol (IP) packet routing; data filtering; access control; service level monitoring; service level management; signal processing; and modulation/demodulation of signals transmitted over the communication medium.

The power line wireless network 104 may be monitored and controlled via a power line server that may be remote from the structure and physical location of the communication nodes. In addition, the wireless access points may be configured and controlled via an access controller which may form part of, or be in communication with, the power line server. Examples of repeaters, backhaul points, power line servers bypass devices and other PLC components are described in U.S. patent application Ser. No. 11/091,677 filed Mar. 28, 2005, Attorney Docket No. CRNT-0239, entitled “Power Line Repeater System and Method,” which is hereby incorporated by reference in its entirety. A detailed description of another example PLCS, its components and features is provided in U.S. patent application Ser. No. 10/973,493 filed Oct. 26, 2004, Attorney Docket No. CRNT-0229, entitled “Power Line Communications System and Method of Operating the Same,” which is hereby incorporated by reference in its entirety.

Of particular significance to the inventions are backhaul nodes and access nodes having a wireless access point (e.g., an integral wireless access point as in access node 134c; a closely coupled wireless access point as in access node 134d). Configuration and control of such backhaul node embodiments and access node embodiments are described below in a separate section.

### Communication Nodes Having a Wireless Access Point

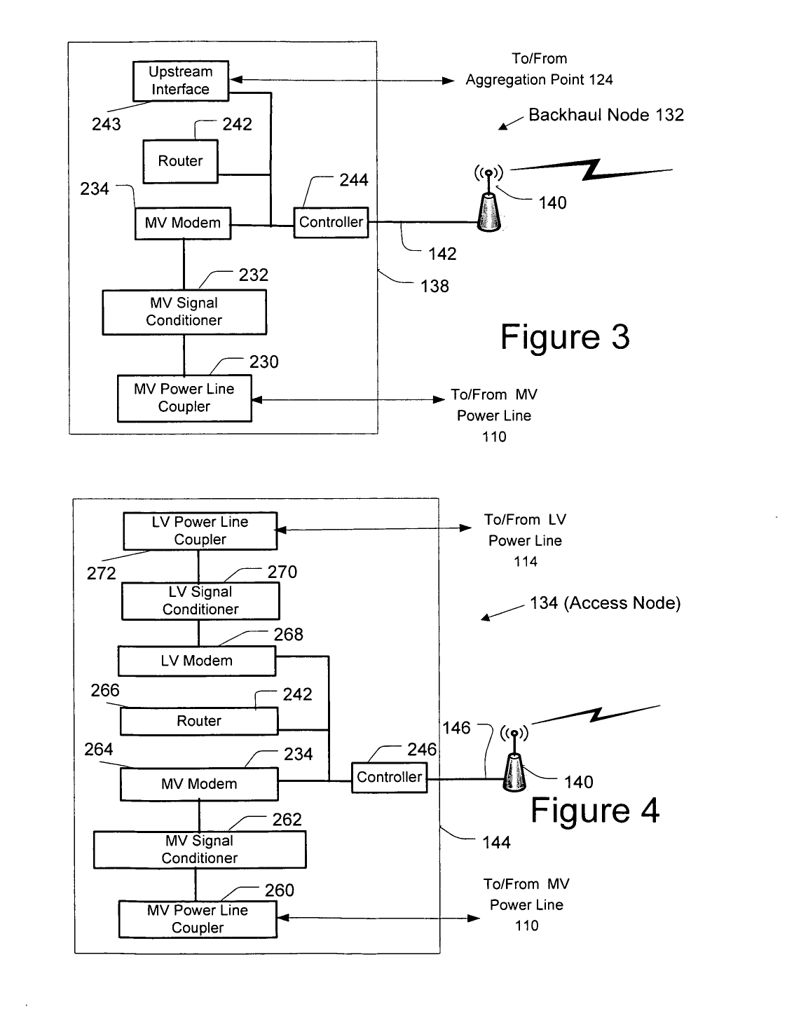

FIG. 3 shows a backhaul node 132 formed by a backhaul point 138 and wireless access point 140. Depending on the embodiment, the wireless access point 140 may be integral with or separate from the backhaul point 138. In one example embodiment a wired connection 142 couples the backhaul point 138 and wireless access point 140.

The backhaul node 132 may include a backhaul point 138 and a access point 140. Depending on the embodiment, the wireless access point 140 may be integral with, or separate from, the backhaul point 138. To communicate data over the MV power lines 110, the backhaul point 138 may include an MV power line coupler 230, an MV signal conditioner 232 and an MV modem 234. The MV power line coupler 230 may prevent the medium voltage power signal from passing from the MV power line 110 to the rest of the backhaul point's circuitry, while allowing the communications signal to pass between the backhaul point 138 and the MV power line 110. The MV signal conditioner 232 may provide amplification, filtering, frequency translation, and transient voltage protection of data signals communicated over the MV power lines 110. Thus, the MV signal conditioner 232 may be formed by a filter, amplifier, a mixer and local oscillator, and other circuits which provide transient voltage protection. The MV modem may demodulate, decrypt, and decode data signals received from the MV signal conditioner 232 and may encode, encrypt, and modulate data signals to be provided to the MV signal conditioner 232.

The backhaul point 138 may also include a router 242 which routes data along an appropriate path (i.e., to the appropriate port), perform prioritization, and other functions. The router 242 receives data packets, matches data packets with specific messages and destinations, performs traffic control functions, performs usage tracking functions, authorizing functions, throughput control functions and similar routing-relating services. The router 242 may route data from the MV power line 110 to the wireless access point 140 and from the wireless access point 140 to the MV power lines 110. In some embodiments the router 242 additionally or alternately may route data (i) from the MV power line or wireless access point 140 to the upstream interface 243, and (ii) from the upstream interface 243 to the MV power line or wireless access point 140. In various embodiments the upstream interface may include a fiber optic transceiver, wireless transceiver, a DSL modem, a cable modem, or another suitable transceiver or modem for communication over a medium coupling the backhaul node 132 and aggregation point 124 (directly or indirectly).

The backhaul point 138 may also include a controller 244 (e.g., that includes a processor) with memory for storing program code—the execution of which controls operations of the backhaul point 138, such as, for example, the routing functions, controlling the access point 140, and other operations. Thus, in one embodiment the router 242 functions may be performed by such a controller 244.

FIG. 4 shows an access node 134 formed by a bypass device 144 and wireless access point 140. Depending on the embodiment, the wireless access point 140 may be integral with, or separate from, the bypass device 144. In an example embodiment a wired connection 146 couples the bypass device 144 and wireless access point 140.

In some embodiments, data may flow through the node 134 along several routes, including: (i) from the MV power line 110 to LV power line 114; (ii) from LV power line 114 to MV power line 110; (iii) from wireless access point 140 to the LV power line 114; (iv) from LV power line 114 to wireless access point 140; (v) from wireless access point 140 to MV power line 110; and (vi) from MV power line 110 to wireless access point 140.

The access node 134 may include an MV coupler 260, MV signal conditioner 252, MV modem 264, router 266, and controller 246, which may include substantially the same components and operate in substantially the manner as those components described for the backhaul none 132.

In addition, this example access node 134 includes a LV power line coupler 272, a LV signal conditioner 270 and a LV modem 268. In one embodiment the LV power line coupler 272 may be an inductive coupler. In another embodiment the LV power line coupler 272 may be a conductive coupler. The LV signal conditioner 270 may provide amplification, filtering, frequency translation, and transient voltage protection of data signals communicated over the LV power lines 114. The LV modem 268 may demodulate, decrypt, and decode data signals received from the LV signal conditioner 270 and may encode, encrypt, and modulate data signals to be provided to the LV signal conditioner 270.

In one example embodiment, the wireless access point, LV modem, and MV modem may have different MAC addresses, IP addresses, and/or port numbers within the access node 134.

In another example embodiment the wireless access point 140 (see FIGS. 3 and 4) includes a wireless transceiver that can be remotely configured to determine the frequency channel, transmission power level, QoS, and/or other communication parameters for data communications. The wireless access point 140 may be implemented as a PCMCIA card plugged into a slot at or coupled to the backhaul point 138 or bypass device 144. In one example embodiment, the wireless access point 140 may be a thin access point that is designed to be remotely controlled and configured and is to be distinguished from ‘smart’ wireless access points that have more “intelligence” to serve as a communication node. Specifically, some or all of the “intelligence” of the thin access points 140 is included elsewhere (e.g., in the access controller) and remote from the wireless access point 140. In embodiments using smart wireless access points 140, the following functions may be performed by the access point itself: packet format conversion, encryption, QoS applications, RF status monitoring, authentication control, wireless to wireless forwarding, stored configuration, class of service, and access control list enforcement. For the thin wireless access point 140, some or all of these functions may be performed at the access controller in real time, near real time, or intermittently. The power line wireless network may use thin wireless access points 140 and smart wireless access points 140.

In a thin wireless access point 140 embodiment having a wireless transceiver and antenna, the wireless transceiver may be connected to (or integrated with) a power line communication device 138/144 as described above. Together the wireless access point 140 and the power line communication device 138/144 form a communication node. The access controller 152 may communicate with and/or control the wireless transceiver through the power line communication device 138/144. In another embodiment the wireless access point includes a modem (e.g., a power line modem) and is coupled to a communication node 128. In such an embodiment, the modem of the wireless access point 140 may be coupled to the access controller 152 through the communication node 128.

The access point 140 may be configured to provide security via IPsec (IP security based on layer 3), to perform multiple frequency band scanning, QoS, and may be automatically discovered and configured by the access controller at power up.

The access points described herein may use any suitable protocol and/or frequency band such as, for example, protocols substantially compatible and/or compliant with the IEEE 802.16 standards, multipoint microwave distribution system (MMDS) standards, IEEE 802.11 (a, b, or g) standards, DOCSIS (Data Over Cable System Interface Specification) signal standards, or another suitable signal set and/or standard. As stated, the access points may use any suitable frequency band. In one example, frequency bands are used that are selected from among ranges of licensed frequency bands (e.g., 6 GHz, 11 GHz, 18 GHz, 23 GHz, 24 GHz, 28 GHz, or 38 GHz band) and unlicensed frequency bands (e.g., 900 MHz, 2.4 GHz, 5.8 Ghz, 24 GHz, 38 GHz, or 60 GHz (i.e., 57-64 GHz)). In another example, frequencies are selected from among other frequency bands including a 75 GHz frequency and a 90 GHz frequency. In one example embodiment, at least some of the access points employ Wifi (IEEE 802.11a, b, or g). IEEE 802.11a access points may use up to eight frequency channels, while only three frequency channels utilized by 802.11b devices. Accordingly, 802.11a access points may be deployed in a more dense manner than, for example 802.11b access points. Up to twelve access points each having a different assigned frequency channel may be deployed in a given area without causing co-channel interference.

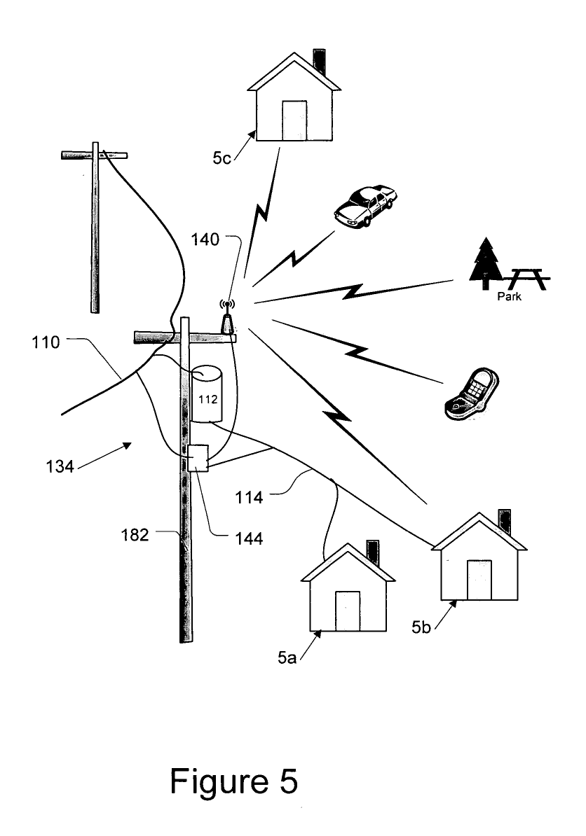

Alternately or in addition thereto, one o more of the access points 140 may be configured to provide mobile telephone communications (digital or analog) and use the signal set and frequency bands suitable to communicate with mobile phones, PDAs, and other devices configured to communicate over a mobile telephone network. Mobile telephone network and mobile telephone communications, as used herein, are meant to include analog and digital cellular telephone networks and communications, respectively, including, but not limited to AMPS, 1G, 2G, 3G, GSM (Global System for Mobile communications), PCS (Personal Communication Services) (sometimes referred to as digital cellular networks), and other cellular telephone networks. One or more of these networks may use various access technologies such as frequency division multiple access (FDMA), time division multiple access (TDMA), or code division multiple access (CDMA) (e.g., some of which may be used by 2G devices) and others may use CDMA2000 (based on 2G Code Division Multiple Access), WCDMA (UMTS)-Wideband Code Division Multiple Access, or TD-SCDMA (e.g., some of which may be used by 3G devices). FIG. 5 illustrates an example implementation of a communication node 128 that comprises an access node 134 located at a distribution transformer 112 on a utility pole 182 and comprising a bypass device 144 and an access point 140. The bypass device is coupled to the wireless access point 140, the MV power line 110, and the LV power line 114. In this embodiment the control messages travel over the MV power line 110, through the power line communication device 144 to the wireless access point 140.

In this example embodiment, the access node 134 may communicate with an upstream device (e.g., a backhaul node or repeater) (not shown) over the MV power line 110 and may also communicate with one or more downstream devices (not shown) for which the node 134 may repeat data on the MV power line. While not shown in FIG. 5, high frequency data signals may sometimes couple form one overhead power line conductor to another though the air. Consequently, the upstream or downstream devices with which the access node 134 communicates may be coupled a different MV power line conductors. This communication node 134 is connected to the LV power lines 114 to communicate with user devices in one or more customer premises 5a,b that are connected to the LV power line 114.

As shown in FIG. 5, the access node 134 may also wirelessly communicate with one or more user devices via its access point 140. For example, access node 134 may wirelessly communicate with user devices in one or more customer premises 5a-c including those customer premises 5a and 5b to which the access node 134 is coupled via the LV power lines 114 (or other wired medium) and also customer premises 5c with which the access node 134 is not electrically coupled. In addition, access node 134 may provide wireless communications to public areas such as parks, sidewalks, etc. Furthermore, access node 134 may provide wireless communications to user devices integrated into or present in stationary or moving automobiles. Further, access node 134 may provide wireless communications to moving or stationary mobile telephones, which communications may be WiFi communications (802.11) or mobile telephone communications (e.g., G1, G2, G3, GSM, AMPS, etc.)—and said mobile telephone may be in a customer premise, in a semi-public or public location, private location, or elsewhere.

While the access point 140 shown in FIG. 5 is shown on top of the utility pole 182, the access point 140 may be mounted anywhere that is safe, convenient, and that provides the desired wireless coverage such as, for example, at the power line communication device 144, below the transformer 144, on a different utility pole, on a street light, on an aerial extension extending upwards or outwards from the utility pole 182 or from a pad mounted transformer.

In one example embodiment of a thin wireless access point, an associated access controller performs some or all of the following functions for a plurality of wireless access points: selecting an encryption key, selecting transmission power levels, bandwidth policing, selecting time slots, bandwidth management, access control, selecting communication frequencies, load balancing, managing hand-offs, and other facets of communication. The wireless access points 140 may have an omni-directional antenna or a directional antenna.

Two commercially available access points that may be suitable in one or more example embodiments include the Aruba 70 Dual-Band, Multi-purpose 802.11 a/big Access Point and the Aruba AP 65, Dual Band 802.11 and b/g Access Point, both by Aruba Networks of Sunnyvale Calif.

Access Controller

In one example embodiment, the access controller manages and coordinates communications among the access points, which may include one or more of managing or controlling transmission power levels, assignment of time slots, bandwidth management, access control (authentication and determining services and service level), communication frequencies (e.g., assigning frequency channels to be used), QoS (e.g., assign a particular QoS), load balancing, security parameters (e.g., assign a particular security level or parameter to an access point or user device or provide an encryption key to an access point), hand-offs, and other facets of communications. To perform these tasks, the access controller may be configured to establish rules that may be used by the access nodes in carrying out these activities. The rules may be propagated from the access controller to the access nodes, or to their access points (if using smart access points), and, in some instances, to the user devices. Alternately, configuration requests may be transmitted from a device to the access controller, which may reply with configuration information in a control message.

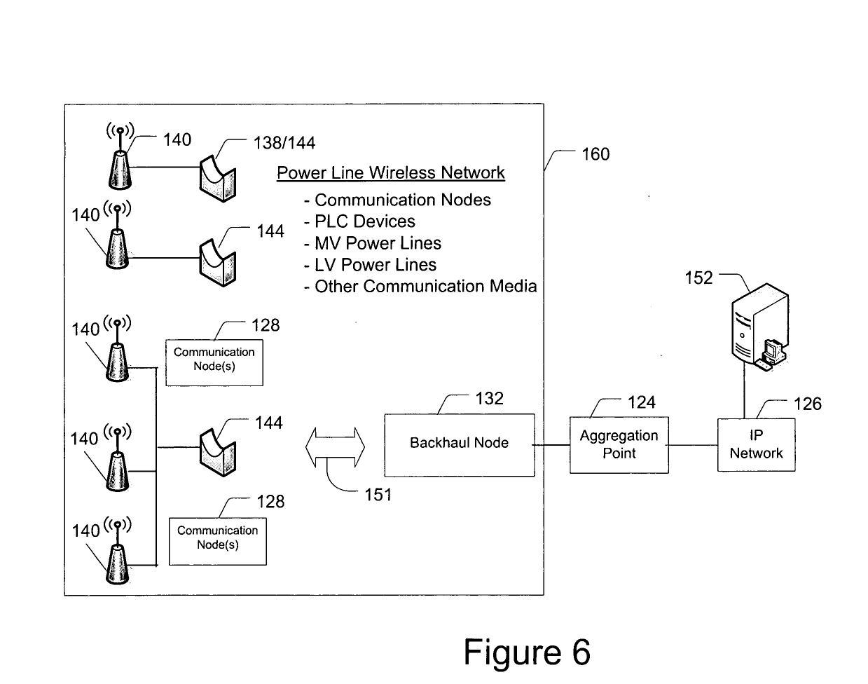

The access controller 152 may include one or more computer systems with memory and executable program code stored therein—the executable program controlling the operation of the access controller 152. As shown in FIG. 6, the access controller may be communicatively linked to the access points (and/or controllers of their associated access nodes) of one or more power line wireless networks and, therefore, depending on the embodiment, may be configured to communicate with the access nodes (the PLC device and/or access point), backhaul nodes, repeaters, and wired and wireless user devices. More specifically, the access controller may receive communication status information related to one or more of the communication nodes and/or communication links of the power line wireless network, which may include, for example, channel quality data, latency data, the number user devices being serviced, types of data being communicated (by a device or link), the amount of data be communicated (total and/or per user device) by a device or over a link, and other information. The access controller may also receive configuration information from one or more devices such as, for example, the encryption key, transmission power, user access lists, and/or frequency channel being used for wired or wireless communications. Such information may be transmitted by the device periodically or intermittently or may be transmitted in response to a control message received from the access controller. In addition, the access controller may transmit control messages to configure the access point such as, control messages that control the transmission power level, the encryption key, the frequency channel, and other parameters to be used by the access point (or PLC device). A Control message may include one or more packets, frames, commands, requests for status information, and/or requests for configuration information. The access controller may unicast, multicast, or broadcast control messages to all communication nodes (and/or their access points) or select nodes over communication paths including wired (e.g., power line, coaxial cable, twisted pair, etc.) and/or wireless segments. Any suitable messaging protocol may be used including Simple Network Management Protocol (SNMP).

The access controller may include a database stored in memory that includes information of the network elements, which may include, for example, the type of network element (e.g., backhaul node, access node, etc.), IP address, location, user device's being serviced, type of communication ports (e.g., power line, wireless, coaxial cable, etc.), and other information. Control messages may be facilitated with layer 2 and/or layer 3 communications

As discussed, the access controller may coordinate what user devices have access to the network and through which access point the user device (if a wireless device) will be associated. In addition, in one example embodiment, the access controller may be configured to detect unauthorized users, ensure user devices do not become associated with other non-affiliated access points, and ensure that user devices need not re-authenticate when moving from access point to access point. The access controller may also determine subscription services and communication parameters based on the user device, type of user device, type of subscriber, time of day, week, or month, and/or location of the user device.

In some embodiments, user devices may request to be associated with a particular access point, which may be the access point with which the user device receives the strongest signal. This request may be transmitted by the access node to the access controller, which may grant the request (by transmitting a control message to the access node to permit association with it) or deny the request and (1) transmit a control message to that access nodes (and others nearby) to deny access to the power line wireless network or (2) assign the user device to a different access node and access point by transmitting to that access node a control message having a command to associate with the requesting user device.

In some embodiments, user devices may select a preferred access point based on criteria stored in the user device. For example, a user device may include executable program code stored therein for processing data of the criteria (e.g., connection preferences, rules sets, exception lists, and connectivity thresholds). The user device may execute the program code in order to associate with the preferred access point (e.g., instead of the access point one with the strongest signal strength and with which many other user devices may be trying to associate).

Thus, a user device may receive service information about one or more access points such as the number of user devices with which the access point is presently communicating, latency, the minimum received signal strength indication (RSSI), service profile (e.g., bit rate information), and other information. The service information may be received by the access controller, stored therein, and transmitted to the user device in a control message. Data of these factors may be weighted to determine the preferred access point with which a user device is to associate. New executable program code and/or weighting factors may be transmitted to the user device from the access controller (or by the access node) in order to modify the process as well. Additionally, different user devices may receive and/or use different weight factors and/or program code (based on the type of device, subscription level of the user, and/or the type of data to be communicated).

The user device may execute the program code to identify the preferred access point with which to associate periodically, intermittently, and/or based on a trigger such as, for example, communication quality falling below a threshold (e.g., data bit rate to low, latency too high, etc.), detection of a signal strength below a threshold, and/or receiving a control message originating from the access controller (or communication node).

In accordance with an example embodiment, a session control process may be adapted to manage and control the user device database (stored in the access controller) and session information for some or all active user devices. In an example embodiment, the access controller may be configured to use session management information that may be used for bandwidth management (i.e., controlling the amount of data traffic). The session control process may be configured to enforce access control (e.g., what services and QoS are available to the user) based on, for example, a user session. Thus, access control may be used to facilitate, for example, QoS management, bandwidth management and load balancing in the network. The session control process may also control and manage switching functions and determine bandwidth availability in order to facilitate hand-offs as user devices move through the network or a forced off access points due to load control. In some embodiments, the user may need to “log in” to the system prior to being granted access. In other embodiments, the user device may be recognized (e.g., by MAC address) by the access controller.

In addition to access control, the access controller may (depending on the wireless protocols used) coordinate and control time division multiple access (TDMA) scheduling in the network. Thus, the access controller may supply control messages that include information of communication schedules for wireless access points and assign time slots for a TDMA system.

In addition, the access controller may provide timing information such as local or global time for synchronization. Time synchronization between access points of access nodes may be useful in a variety of applications. For example, in a TDMA system, each access point may be allocated a time slot for transmission, which may be transmitted by the access controller. Time synchronization may be useful in TDMA systems so that each of the access points in the system may identify the start and end of each of the time slots to thereby prevent interference.

In addition to managing access control, the access controller may control and manage distribution of loads. As the traffic through each access node (or access point thereof) changes, either because the activity of the user devices varies or because of handoff of user devices between nodes, the distribution of loads among the access nodes and access points may change. Highly uneven distribution of loads can affect the communications (e.g., quality of service or QoS) provided to the user devices.

If at any time the access controller determines that one of the access nodes (or access points) has a load that is affecting (or could affect) the communications with user devices which are communicating through it, the access controller may execute program code to initiate a load redistribution process to redistribute the load by re-assigning user devices associated with that access point to a new access point (on the same or a different access node). Thus, the access controller may transit a control message information to the access node(s), which responds by transmitting information to the user device (via the access points or LV power line) that facilitates the re-assignment. In an example embodiment, access nodes may each include a list of the user devices that are associated with its access point(s) (or in communication with that access point) stored in memory and which may be used for load balancing and other functions described herein. This information may periodically be transmitted to the access controller. Alternately, or in addition thereto, the access controller may transmit information to the user device to facilitate the re-assignment.

Also, many user devices may be capable of communicating over the power line wireless network via one or more wired connection (e.g., power line, DSL, and/or coaxial cable) and one or more wireless connections. Consequently, the access controller may select any one or more of the connections to provide communications to the device and may also re-configure the devices' connections according to rules for load management, bandwidth, QoS and other parameters.

In addition to load balancing, the access controller may manage communications to provide QoS. Wireless networks typically require communications to coordinate and maintain communication, particularly when the network must support quality of service (QoS). The dynamic nature of radio frequency (RF) channels may mean that connectivity and connection quality between devices may change from time to time and as mobile device move through the network. Thus, nodes may frequently re-negotiate a QoS or other parameter to maintain coordinated communication.

In one example, prioritization and processing of data may be based on acceptable levels of latency and bandwidth availability. An IP telephone call may be assigned higher queuing and processing priority in order to minimize latency. In addition, to support QoS bandwidth management, for example, may include performing activities which may limit and control the usage of available bandwidth based on a particular user device, a type of user device, and/or a type of data.

Based on QoS related information (or other information) received from one or more access nodes, the access controller may force a user device to roam or find a new access point with which to associate. Such an occurrence may result, for example, when the access controller determines that there is insufficient bandwidth (over any wireless or wired link), or too high a latency to provide a minimal acceptable QoS.

The access controller may transmit a control message to the access node (or its access point) and/or to the user device to initiate a re-assignment, which initiates execution of program code in the access node (or user device) to facilitate the re-assignment. Additionally, by transmitting the appropriate control message(s) the access controller may re-assign the user device to a wired connection (e.g., a power line, coaxial cable, DSL, or fiber optic cable connection) if the user device was so equipped instead of, or in addition to, assigning a new wireless access point.

In either event, after the re-assignment, the access controller may receive confirmation thereof (e.g., from the access node and/or user device) and update its database. In one example embodiment, monitoring of the load distributions is performed at the application layer.

As discussed herein, in one example embodiment the access controller may manage the frequency channel and/or transmission power levels of access points that are physically located near each other to reduce or prevent interference (and for other purposes). For example, those access points that are providing overlapping coverage may be allocated different frequency channels. Those access points whose coverage does not overlap may be allocated the same frequency channel but limited in their transmission power levels so as to ensure that their transmissions do not overlap and that they cannot “hear each other.” In one embodiment, each access point may perform signal strength measurements on nearby access points and/or the same user devices, which data may be transmitted to the access controller to facilitate power and frequency control. In some instances, the access controller may transmit control messages to turn off (e.g., power down) one or more access points in the network.

In an example embodiment in which the wireless transceivers of the access points are capable of mobile telephone communications, the power line wireless network may also form part of a larger mobile telephone network. In one embodiment some communication nodes (e.g., backhaul nodes) may be equipped with mobile telephone capable access points while others (e.g., access nodes) may be equipped with Wifi (i.e., IEEE 802.11) access points. Some mobile telephones include Wifi communication capabilities (in addition to mobile telephone communication capabilities). Consequently, the access controller may switch a mobile telephone's communications between Wifi communications and mobile telephone network communications in accordance with the methods and concerns described herein. Thus, if the access controller determines that a mobile telephone user device is not obtaining minimum QoS while communicating (e.g., a voice communication) via Wifi, the user device may be re-assigned to an access point providing mobile telephone network communications, preferably seamlessly.

In some embodiments, some of the management and network coordination may be performed by the access nodes and/or backhaul nodes. For example, handoff of mobile user devices may be more efficiently managed by and between nearby or adjacent communication nodes.

Furthermore, due to configuration by the access controller or via other suitable means, each user device in one example embodiment may communicate different types of data simultaneously (or contemporaneously) though different communication channels. For example, audio and computer data (e.g., HTML and email) may be transmitted wirelessly and video data may be transmitted via the low voltage power line (or another medium). Additionally, one data type may be communicated wirelessly with a first access node and a second data type may be communicated wirelessly or via a wired connection with a second access node. In either event, the access controller may assign and/or store information of the user device and its one or more uplink nodes and ports (e.g., wireless and LV power line ports).

In one embodiment, the access controller 152 and its functions may be distributed. For example, one or more of the access controller functions described herein may be performed by one or more communication nodes. In one embodiment, a backhaul node may manage, coordinate, and control the access controller functions (e.g., bandwidth management, access control, communication frequencies, security parameters, load balancing, and others) of the devices connected to the (its) MV power line. In addition or alternately, each access node may manage, coordinate, and control the access controller functions (e.g., transmission power levels, bandwidth policing, bandwidth management, access control, communication frequencies, load balancing, security parameters, hand-offs, and other facets of communications) for its subnet. Thus, each communication node may communicate with other nearby communication nodes (wirelessly, via a power line, and/or via another communication medium) to coordinate control of their respective access points. For example, in one example embodiment, each access point may perform signal strength measurements on nearby access points. Each access point (via execution of program code therein) may select or negotiate and select their own frequency channel(s) through communications with nearby access points or nodes.

The access controller may facilitate control in any number of methods. For example, depending on the particular control parameter and the system, the access controller may transmit one or more control messages to (1) one or more access points; (2) to one or more access points and PLC devices (i.e., for reception and response from its controller); (3) PLC devices associated with a access point, which may then provide control commands to the access point and, which may transmit commands to (and receive responses from) the user device. In combination with transmitting control messages to any of these devices (or combinations of devices), the access controller may also transmit control messages to the user device(s).

FIGS. 6 show an example embodiment of a power line wireless network 160 in which an access controller 152 sends control communications to a plurality of wireless access points 140. Specifically, FIG. 6 shows an example embodiment of a power line wireless communication network 160 in which the access controller 152 sends control communications to the thin wireless access points 140 via an IP network 126 (e.g., the Internet). The control messages may be transmitted from the IP network 126 into the power line wireless communication network 160 at a backhaul node 132. The control messages then traverse the network 160 to the wireless access points 140.

A downstream data or control message enters the network 160 at the backhaul node 132 and is routed along a communication path 151 to a communication node 128, (which may be formed by a power line communication device 144 that may also include a wireless access point 140). Similarly an upstream communication may be routed along a communication path 151 to the backhaul node 132. The communication path 151 may include a power line, such as an MV power line and/or LV power line. Depending on the relative locations of the backhaul node 132 and the communication node 128, the communication path 151 may also include one or more other communication nodes 128, which may serve as repeaters. It is noted that the communication path 151 may vary for various communications, embodiments, implementations, and even communications having the same source and/or destination.

In another example embodiment, the plurality of wireless access points 140 may be wired to an access controller 152 by a cable, (e.g., a coaxial cable; a twisted pair; a fiber optic cable). In yet another alternative embodiment, the plurality of wireless access points 140 may be wirelessly coupled to the access controller 152 using a wireless protocol (e.g., IEEE 802.11, IEEE 802.16, satellite protocol such as WildBlue®).

As previously described, the backhaul point 138 and bypass device 144 may include a controller 244/246. In one example, controller 244/246 responds to control messages sent by the access controller 152 to control the wireless access point 140 operations. Specifically, the controller 244/246 may include program code stored in memory, and is configured to receive and respond to control messages from the access controller 152. Further in some embodiments, the access controller 152 control messages may be sent over a twisted pair, coaxial cable, fiber optic cable, or a wireless medium and may be routed to the local controller 244/246 of a given node 128 which in response controls the wireless access point 140 of such node 128 or provides commands to the access point 140 (which re-configures according to the commands).

Thus, among the operations performed by the local controller 244/246 may be operations to control the wireless access point 140. In addition some parameter data may be monitored by the controller 244/246. In other embodiments the path between the local controller 244/246 and the wireless access point 140 traverse through the router 242, 266 for sending commands and receiving parameter data. In various embodiments one or more of the following wireless access point operations and communication parameters may be controlled/monitored by the local controller 244/246 in response to control messages received from the access controller 152 and/or via execution of rules and algorithms in program stored in memory of the controller. These parameters may include, for example, wireless communication frequency channel, transmission power level, data communication priority level, packet format conversion, QoS applications, RF status monitoring, authentication control, wireless to wireless forwarding, stored configuration, console port configuration, class of service, access control list enforcement, encryption (e.g., to encrypt or not), and encryption key processing (e.g., encryption key to use).

One advantage of having multiple wireless access points 140 controlled by an access controller 152 is that communication frequencies (channels) can be re-used in some instances. In its database, the access controller 152 may include or determine information about the location or relative position of (e.g., distance between) one or more of the wireless access points 140. The access controller 152 also may have or determine information about the transmission power being used by one or more of the access points 140. Specifically, in some embodiments the access controller 152 may send control messages to determine and/or control the transmission power used by a first access point 140. Based on this data, the access controller 152 can determine whether one or more nearby access points 140 are sufficiently far enough away (from the first access point 140) so as not to interfere with, or be interfered with, communications of the first access point 140 when using the same or overlapping frequency bands. In some embodiments the access controller 142 also may receive response data from the access node (or its wireless access points 140) and/or user devices to determine whether there are communications at the wireless access point 140 that would interfere with communications by that access point. For example, in response to one or more control messages from the access controller 152, a first access point 140 (or user device) may “listen” in one or more frequency bands while (in response to one or more control messages from the access controller 152), one or more other access points 140 may “ransmit” in one or more frequency bands. Depending on the strength of signals received (or whether anything was received) by the first access point 140 (or user device), the access controller 152 may be able to determine if two or more access points 140 interfere with one another and if so, control them so as to use orthogonal frequency channels and, if not, permit them to use the same frequency channel.

Accordingly, the access controller 152 facilitates the re-use of frequencies more readily. For example, access points 140 that are spaced sufficiently apart and out of communication range of each other could all (simultaneously) be allocated the same frequency channel by the access controller 152. Another advantage is that the access controller 152 can select an access point 140 to service a user device 130. Thus, by selecting a communication node 128 that has an access point 140 that is not substantially utilized to its maximum capacity (i.e., that is less “crowded”), is communicating less data (per unit of time), or is servicing fewer user devices 130, better communication services may be provided. Additionally, if the power line server is also acting as the access controller 152 (or if the access controller 152 receives the appropriate information), it may also select an access point 140 that forms part of a communication node 128 that is less crowded (e.g., via its LV power line port or due to communications repeated over the MV power line), servicing fewer user devices through other ports, or that is coupled to an upstream communication medium (e.g., MV power line) that has greater bandwidth available.

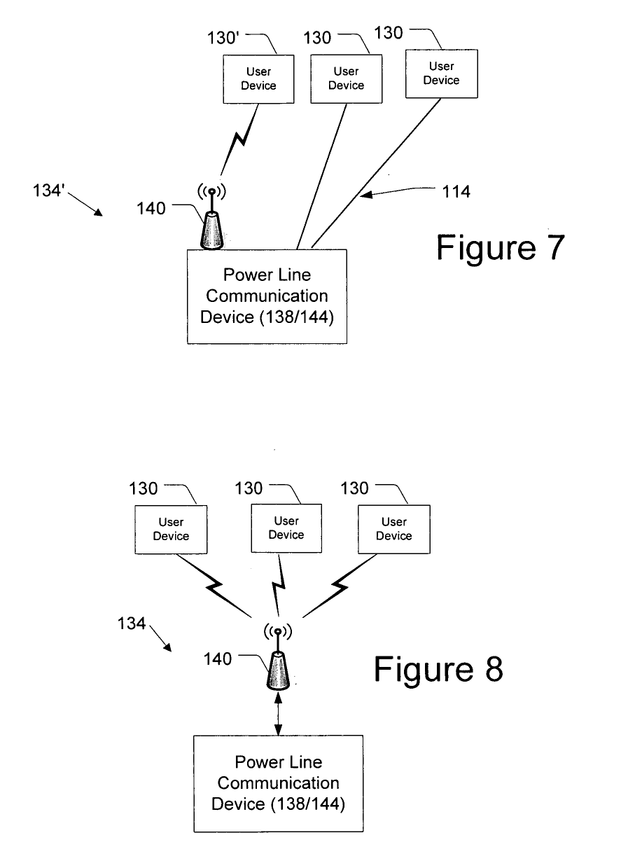

FIGS. 7-12 show various configurations of a portion of the power line wireless network 104 including a wireless access point 140. FIG. 7 shows an access node 134′ which links one or more user devices 130 using differing media. In various embodiments, the link between the access node 134′ and the user devices 130 may be over an LV power line 114, or other wired or wireless media. Accordingly, in some embodiments an access node 134′ may include multiple interfaces for communicating to different user devices 130 over different media. In this example embodiment, the access node 134 includes at least one access point 140 (communicating with one or more user devices 130′) and one power line port communicating with a plurality of user devices 130 over different external LV power lines.

FIG. 8 shows an example access node 134 that includes a power line communication device 138/144 and a wireless access point 140 serving a plurality of user devices 130 over time separated wireless links (i.e., time division multiplexing).

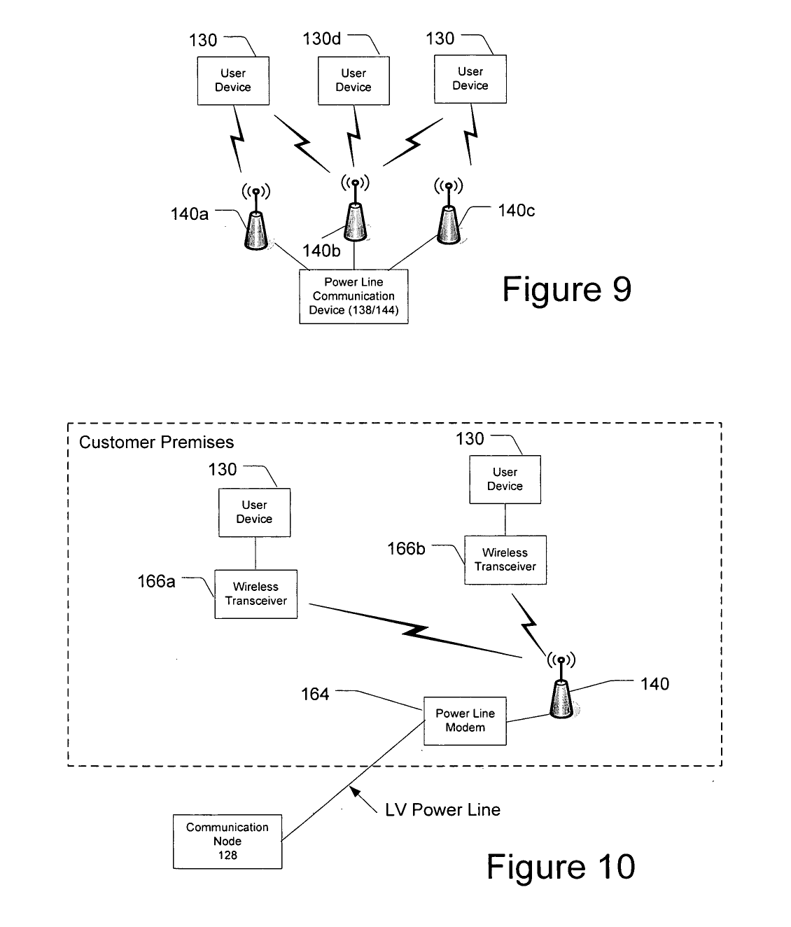

FIG. 9 shows an example embodiment of an access node 134 that includes a plurality of wireless access points 140a-c linked to a power line communication device 138/144 to improve capacity in a given area. In one embodiment the wireless access points 140a-c are redundant, being located in a common place to improve capacity and reliability. Thus, in one embodiment of this configuration, one access point 140a may provide communications to a user device 130d during one time slot, while during another time slot another wireless access point 140b may serve the user device 130d. Although FIG. 9 shows one access node (formed by the power line communication device 138/144 and wireless access points 140a-c) serving a plurality of user devices 130 with overlapping coverage, other embodiments may provide overlapping coverage from multiple access nodes 134 (i.e., from multiple wireless access points 140 with different power line communication devices 138/144). To prevent interference, each access point 140a-c may be allocated a different frequency band. Additionally, where overlapping wireless coverage exists, the access controller 152 may determine which access point 140 services which user device 130. In another embodiment the wireless access points 140a-c are separately located to cover different areas. As described elsewhere herein, the user devices with which the access points 140 communicate may comprise a wireless capable computer, a personal digital assistant, a mobile telephone, a Voice over IP (e.g., Wifi) telephone, or other device.

The user devices described herein may be a connected to a wireless access point 140 directly (e.g., via its own wireless transceiver) or via a wireless transceiver in the customer premises that connects a plurality of such devices to the access point 140. For example, such a wireless transceiver may include an antenna mounted inside or external to the customer premises (e.g., on a digital broadcast antenna) and be connected via power line or other cable (e.g., the coaxial cable connected to the DBS antenna) to the modem circuitry of the wireless transceiver (which may receive control messages from the access controller), which may be connected via power line or other cable to the user device(s). Thus, the in-home managed access point may be connected wirelessly or via power lines to an in-home power line communication network (e.g., a HomePlug network)

FIG. 10 shows a portion of a power line wireless network that includes an in-home managed wireless access point 140. In the customer premises the network includes wireless transceivers 166a-b for communicating with the wireless access point 140. A power line modem 164 is coupled to (or integrate with) the wireless access point 140. The power line modem 164 is connected to the LV power lines at the customer premises to communicate with the communication node 128 servicing the customer premises. Thus, the user devices 130 access the network through their wireless transceivers 166a-b. The wireless access point 140 may be configured remotely via the access controller 152 as described herein even though it is physically located separate from the power line communication device forming the connection node 128 and is in, or at, the customer premises. Additionally, the access point 140 in, or at, the customer premises also may be configured to provide communications for user devices external to the customer premises such as user devices disposed at, for example, nearby residences (apartments, offices, houses, businesses), streets, common areas, public areas, semi-public areas, and, therefore, is not limited to servicing a particular subscriber or physical location.

FIG. 10, of course, is simply a representative example embodiment. A single access node 134 may be implemented with a power line communication device 138/144 and numerous access points 140 disposed in a plurality of customer premises and also one or more external to the customer premises to provide thorough coverage of a given physical area. Additionally, any of the in-home PLC networks or wireless networks (i.e., local area networks (LANs) or wireless LANs) may include a router and a router may be connected to the access point 140 or integrated with the access point 140 (i.e., form part of the wireless LAN) and also allow file sharing and other data transfer between user devices. It will be evident to those skilled in the art that the ability to coordinate and control the configuration of numerous access points 140 with overlapping coverage (e.g., in adjacent or nearby homes, apartments, and other areas) can reduce interference and provide improved wireless service to customers.

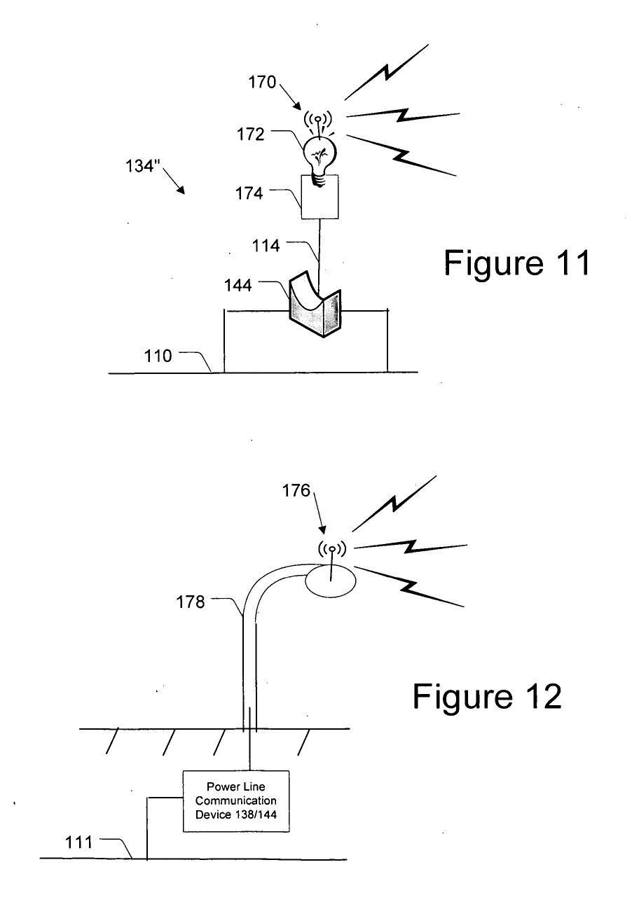

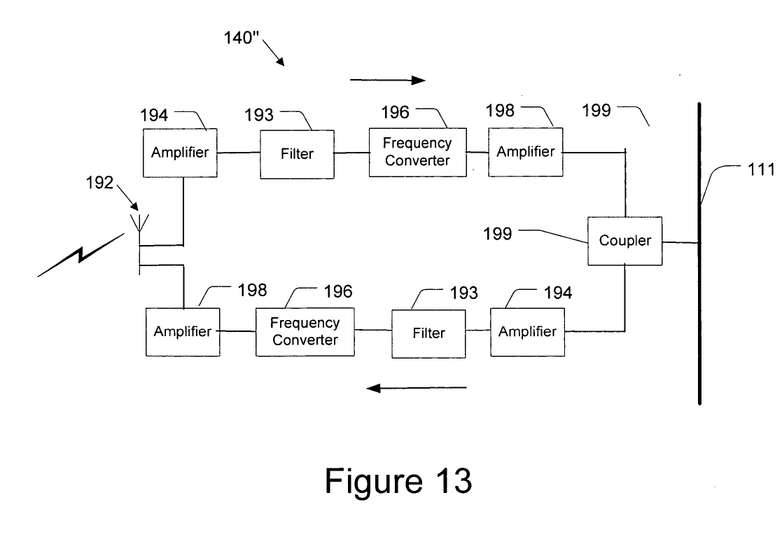

FIG. 11 shows an access node 134″ in which the wireless access point 170 is located remote from its power line communication device 144. Specifically, a wireless access point 170 is integrated into a light bulb 172 that fits into a light socket 174. Accordingly, the wireless access point 170 may be located in a home, office, or building unit and managed by an access controller or PLC device. Communications upstream with its PLC device 144 may occur along the LV power line 114 wired to the light socket 174. Communications to user devices may occur wirelessly. The wireless access point 170 may include a wireless transceiver and a power line modem. In still another embodiment the wireless access point 170 is formed by the filter, amplifier, and other components shown below in FIG. 13.

FIG. 12 shows another access node in which the wireless access point 176 is located remote from a power line communication device 138/144. Specifically, the wireless access point 176 of this example is located at a street lamp 178. The access point 176 may be integrated into the street lamp or merely located at the street lamp fixture or pole. Communications with its power line communication device 138/144 may occur along an LV power line or another wire medium. The power line communication device 138/144 may be coupled to a power line 111 that is a MV or LV power line. Communications with user devices may occur wirelessly. The wireless access point 176 may include a wireless transceiver and a power line modem. In other embodiment, the access point may be located at an intersection or connected to a street light, traffic light, or other device connected to power lines to provide wireless coverage.

FIG. 13 shows an alternative embodiment of a power line wireless access point 140′ where the wireless access point 140′ includes filters 193; amplifiers 194,198; frequency converters 196; and signal couplers 199 and does not include a modem. In such alternative embodiment upstream communications from a user device 130 may be received at an antenna 192. The antenna is connected to a first amplifier 194, which is connected to a filter 193 (for filtering for the frequency band to be received). The filtered signal is then directed to frequency converter 196 which converts the received signal frequency to the desired band for communication over the power line 111 (e.g., an orthogonal frequency band for communication within the power line wireless communication network 104). The frequency converter 196 is connected to a second amplifier 198 which amplifies the signal. The signal, amplified by the second amplifier 198, is coupled to a power line (e.g., an MV power line 110) by a coupler 199 for communication over the power line 111 (e.g., without demodulating, decoding, decrypting, processing, encoding, encrypting, or modulating). An advantage of this embodiment is that there is less latency than the latency resulting from demodulation, routing, and re-modulation by one or more modems. A similar set of components is included for moving data from the power line for transmission through the antenna in the downstream direction to a user device 130.

In one example embodiment, the wireless access points 140 do not have a network address. Accordingly, communications do not involve level 3 (the network layer) of the OSI model. The level 3 functions may be performed by the router at the node 128 formed by (in part) the wireless access point 140 or by the access controller.

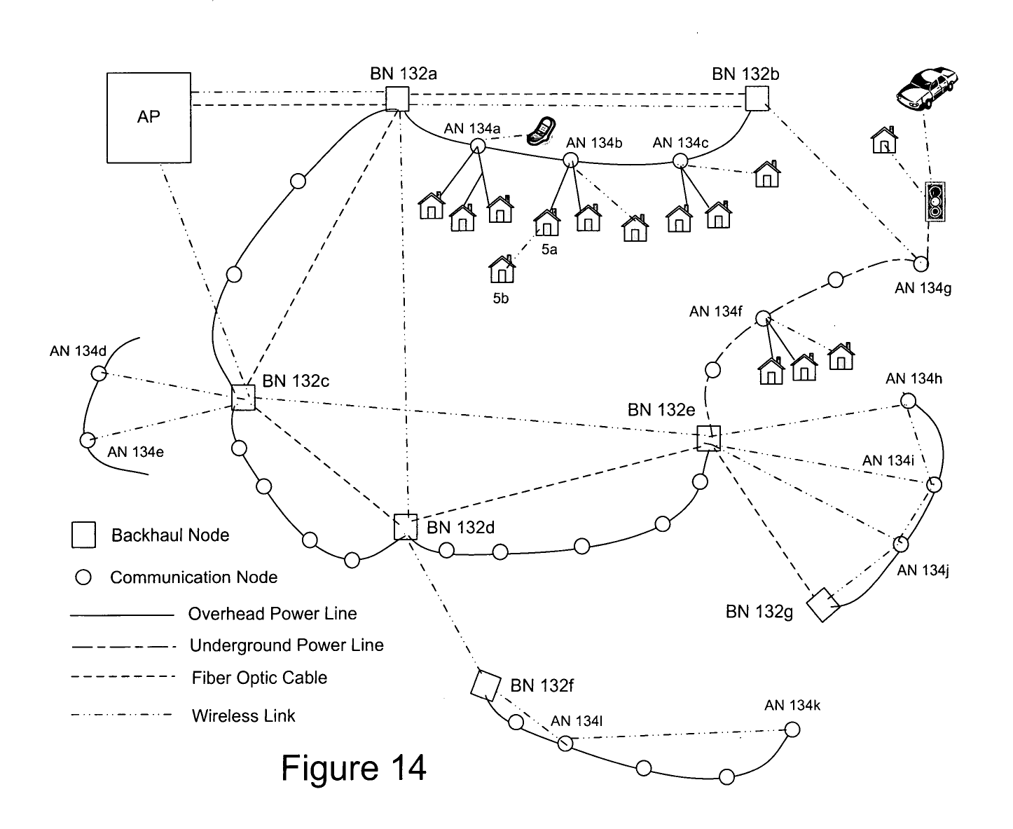

While the embodiment described herein may use power line or other wired media for upstream communications from the access nodes and backhaul nodes, other embodiments may use wireless links. FIG. 14 illustrates an example embodiment of a power line wireless network in which each access point 134 includes a wireless access point (not shown) co-located with a PLC device. As shown in the figure, access points of some access nodes 134k may wirelessly communicate with other access points 1341 “upstream”, which may provide (in some embodiments) parallel wired and wireless upstream communication paths. For example, access point 134k has two communication paths to its backhaul node 132f—one that is via the overhead power line and another that is via a wireless link through access node 1341. Thus, in this example embodiment, the controller in the access node 1341 may receive the data via its access point and re-transmit the data (e.g., after changing header data such as address information) via the access point for reception by another access point (that of backhaul node 132f). One skilled in the art will recognize that such a system may therefore include redundancy that may improve reliability of the system and increase bandwidth due to multiple communication paths. As shown in FIG. 14, some access points 134h-j may be coupled to more than one backhaul node 132e and 132g via wired and/or wireless communication links and some access points 134d and 134e may be coupled to a backhaul node 132c only via a wireless link because, for example, there is no power line physically between the devices or because there is no bandwidth available over a power line or elsewhere. As discussed elsewhere herein, some access points 134g may be wirelessly coupled to wireless access points elsewhere such as at a traffic light, street light or other public or semi-public area. In addition, some backhaul points 132e may be communicatively linked to more than one upstream backhaul node 132d and 132c (or other device) via wired and wireless connections and thereby connected to the aggregation point via parallel redundant communication paths. Similarly, backhaul node 132d is communicatively linked to backhaul node 132a and 132c. Another backhaul node 132b may have multiple communication links to its upstream backhaul node 132a.

As illustrated, the wireless access points and associated access nodes linked together may provide a mesh network to allow for a plurality of wireless communication paths between at least some pairs of wireless access points and a plurality wired paths as well. Again, this may further improve reliability and capacity. Control of with which wireless access points the wireless access points communicate may be determined (assigned) by the access controller, self-determined, and/or determined by any means described herein or by other suitable means. Additionally, fiber optic cables and other media may not be available early in the deployment of the power line wireless network. Consequently, it may be desirable to provide backhaul communications from some backhaul nodes (and some access nodes) wirelessly via the access points and later, after fiber is readily available and/or customer demands warrants installation of fiber or other media, using fiber or other media for the backhaul links from the backhaul nodes.

In addition to switching communications of user devices and access nodes between wireless and power line, the present invention may also be used to switch communications between power line communications and coaxial cable (e.g., DOCSIS), between coaxial cable and twisted pair (e.g., DSL), between power line and twisted pair, and between wireless and any of twisted pair, coaxial cable, or fiber optic communications by providing the appropriate control messages to the communication node and/or user device. As discussed above, the communications of the user device or communication node may switch to a different media (e.g., by the access controller) based on latency, bandwidth, QoS, load management considerations, and/or other reasons.

As discussed, an access node may be communicatively coupled to a customer premise via a fiber optic cable, coaxial cable, twisted pair or other wired connection. In such an embodiment, it may be desirable to communicate what are conventional wireless data signals (e.g., a Wifi signal set) over the coaxial cable or other medium. In doing so, it may necessary or desirable to frequency shift the signals prior to communicating over the wired medium. Thus, Wifi signals may be transmitted from the access node over a coaxial cable to the customer premise and supplied passively (or amplified) to an antenna and/or leaky coaxial cable. Communications from the customer premises may likewise be frequency shifted and/or amplified for reception by the access node. Some embodiments of the present invention may also be used with devices that communicate Wifi and other conventionally wireless data signals over the wires by applying the signals to the wire at the physical layer. For example, the WirePlus Broadband, offered commercially by SercoNet may be used.

In some embodiments, a customer's wireless router may be configured (according to one or more embodiments described herein) via program code (received via a power line communication) executed on the user computer system or a user device.

The power line wireless network may use wireless access points and both underground and overhead MV and LV power lines as well as other communication media. Some embodiments may use picocells (very small coverage areas) and a Wifi or Bluetooth® transceiver.

In addition to providing communications services, the system may also be configured to provide location information about users. For example, if a parent (or employer) wishes to learn the location of their child (employee), a request may be transmitted from the parent (or employer). In response, the access controller may determine the location of the access node with which the user's user device is communicating and transmit location information to the parent (or employer). In addition, in an example embodiment, in response to a control message from the access controller, two or more the wireless access points may be configured to determine a more precise location of a user via triangulation or other methods well known in the art.

In one embodiment, some customers may have broadband service provided by a cable, a DSL, fiber optic, or a wireless WAN ISP operator. Such users may already have an in-home wireless network and/or an in-home PLC network. One or more example embodiments of the present invention may allow the user of such a broadband service to easily connect to the power line wireless network through their existing power line modem or wireless access point. Additionally, the access controller may also reduce interference between the power line wireless network and such in-home networks according to the methods described herein.

One or more of the access points described herein may include a MIMO (multiple-in, multiple-out) antenna, phased array antenna, or multiple antenna elements. In addition, a leaky coaxial cable (connected to a managed access point) may be used inside one or more buildings.

In some implementations of the present invention, multiple wireless capable communication nodes may overlap. For example, two or more of such wireless capable communication nodes using the same frequency channel may be spaced apart and mounted to utility poles. A third wireless capable communication node may be mounted on a tower (higher than other two), use a second frequency channel, and provide wireless coverage that is redundant the other two wireless capable communication nodes. It will be evident to those skilled in the art that the present invention may be used to provide broadband service (e.g., broadband over power line and/or broadband wireless) over a large geographical area—such as town, city, county, or state—and can provide service to both indoor and outdoor locations.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A power line wireless communication system, comprising:
a wireless transceiver configured to wirelessly communicate user data with one or more user devices;
a power line communication device coupled to the wireless transceiver and a power line;
an access controller remote from said wireless transceiver and configured to control at least one communication parameter of said wireless transceiver; and
wherein the user data traverses a communication path that includes the power line, said power line communication device, said wireless transceiver, and a wireless link.

2. The system of claim 1, wherein the power line comprises a medium voltage power line.

3. The system of claim 2, wherein said power line communication device is further coupled to a low voltage power line.

4. The system of claim 1, wherein said at least one communication parameter comprises a transmission power level of said wireless transceiver.

5. The system of claim 4, wherein said at least one communication parameter further comprises a wireless communication frequency of said wireless transceiver.

6. The system of claim 1, wherein said at least one communication parameter comprises a wireless communication frequency of said wireless transceiver.

7. The system of claim 1, wherein said at least one communication parameter further comprises an encryption key to be used by said wireless transceiver for communicating user data.

8. The system of claim 1, wherein said wireless transceiver is one of a plurality of wireless transceivers configured to provide wireless communications to one or more user devices; and
wherein said access controller is configured to control at least one communication parameter of said plurality of wireless transceivers.

9. The system of claim 1, wherein said wireless transceiver is one of a plurality of wireless transceivers configured to provide communications to a plurality of user devices;
wherein each of said plurality of wireless transceivers provides wireless communications over a coverage area; and
wherein at least some of said plurality of wireless transceivers have overlapping coverage areas.

10. The system of claim 9, wherein said access controller is configured to select one of said plurality of wireless transceivers to provide communications to a user device located in an overlapping coverage area.

11. The system of claim 9, wherein said access controller is configured to allocate different frequency channels to at least some wireless transceivers having overlapping coverage areas.

12. The system of claim 9, wherein said access controller is configured to allocate different time slots to at least some wireless transceivers having overlapping coverage areas.

13. The system of claim 9, wherein said access controller is configured to at least partially control the hand-off of a user device that moves from the coverage area of first wireless transceiver to the coverage area of a second wireless transceiver.

14. The system of claim 1, wherein said access controller is configured to receive information of data traffic of at least some of said plurality of wireless transceivers to perform load distribution processing based on said information.

15. The system of claim 14, wherein said access controller is configured to re-distribute the load of a plurality of said wireless transceivers by transmitting one or more control messages.

16. The system of claim 1, wherein information of said at least one communication parameter is included in a control message that traverses a low voltage power line in route to said wireless transceiver.

17. The system of claim 1, wherein information of said at least one communication parameter is included in a control message that traverses a medium voltage power line in route to said wireless transceiver.

18. The system of claim 1, wherein said power line communication device is configured to provide communications to one or more user devices via a low voltage power line.

19. The system of claim 1, wherein said wireless transceiver is disposed in a customer premises and coupled to said power line communication device via a low voltage power line.

20. The system of claim 1, wherein said wireless transceiver is attached to a street light.

21. The system of claim 1, wherein said wireless transceiver is coupled to a light socket and wherein information of said at least one communication parameter is included in a control message that traverses a low voltage power line coupled to the light socket.

22. The system of claim 1, wherein said access controller is configured to control said at least one communication parameter of said wireless transceiver by transmitting a control message to said power line communication device and said power line communication device is configured to control said at least one communication parameter of said wireless transceiver in response to receiving said control message.

23. The system of claim 1, wherein said access controller is configured to control said at least one communication parameter of said wireless transceiver by transmitting a control message to said wireless transceiver.

24. The system of claim 1, wherein said access controller is configured to control at least one communication parameter a user device by transmitting a control message to the user device.

25. The system of claim 1, wherein said access controller is configured to perform access control functions for said wireless transceiver.

26. A method of operating a power line wireless communication system, comprising:
receiving a control message at a wireless access point, wherein said control message traverses a power line;
establishing a wireless communication link between the wireless access point and a user device, said wireless communication link having at least one communication parameter according to information in the control message; and
receiving user data from the user device via said wireless communication link; and
transmitting the user data over the power line.

27. The method of claim 26, further comprising establishing a power line communication link between a power line communications device and a user device, wherein said power line communication device is coupled to said wireless access point.

28. The method of claim 27, wherein transmitting the user data over the power line is performed by said power line communication device.

29. The method of claim 28, wherein the power line comprises a medium voltage power line.

30. The method of claim 26, wherein the control message includes information of a transmission power level to be used by the wireless access point.

31. The method of claim 26, wherein the control message includes information of a communication frequency to be used by the wireless access point.

32. The method of claim 26, wherein the control message includes information of an encryption parameter to be used by the wireless access point.

33. The method of claim 26, wherein the wireless access point is one of a plurality of wireless access points configured to provide communications to a plurality of user devices;
wherein each of the plurality of wireless access points provides wireless communications over a coverage area; and
wherein at least some of the plurality of wireless access points have overlapping coverage areas.

34. The method of claim 33, further comprising selecting one of the plurality of wireless access points to provide communications to a user device located in an overlapping coverage area; and
transmitting a control message that traverses the power line to cause the selected access point to provide communications to the user device located in the overlapping coverage area.

35. The method of claim 33, further comprising allocating different frequency channels to at least some wireless access points having overlapping coverage areas.

36. The method of claim 33, further comprising allocating different time slots to at least some wireless access points having overlapping coverage areas.

37. The method of claim 33, further comprising transmitting a control message to a wireless access point to, at least partially, control the hand-off of a user device that moves from a first coverage area to a second coverage area.

38. The method of claim 33, further comprising:
receiving information of data traffic of at least some of the plurality of wireless access points; and
performing load distribution processing based, at least in part, on said received information.

39. The method of claim 38, further comprising transmitting one or more control messages to one or more of the plurality of wireless access points to re-distribute a load.

40. The method of claim 26, wherein the wireless access point is located in a customer premises.

41. The method of claim 26, further comprising at a remote device:
receiving a request to communicate with the wireless access point;
transmitting a response to the request; and
wherein the response and request traverse the power line.

42. A power line wireless communication system, comprising:
a plurality of communication nodes, each node comprising a wireless transceiver and a controller communicatively coupled to said wireless transceiver; and
an access controller configured to transmit control messages that traverse at least one power line to remotely configure one or more communication parameters of said wireless transceivers.

43. The system of claim 42, wherein said controller of each of said plurality of communication nodes is configured to respond to a control message transmitted from the access controller to control a communication frequency of said wireless transceiver.

44. The system of claim 42, wherein said controller of each of said plurality of communication nodes is configured to respond to a control message transmitted from the access controller to control a transmission power level of said wireless transceiver.

45. The system of claim 42, wherein said controller of each of said plurality of communication nodes is configured to respond to a control message transmitted from the access controller to control an encryption key used by said wireless transceiver.

46. The system of claim 42, wherein the at least one power line includes a medium voltage power line.

47. The system of claim 46, wherein said communication node is further coupled to a low voltage power line to communicate therethrough with one or more user devices.

48. The system of claim 42, wherein each of said wireless transceivers of said plurality of communication nodes provided wireless communications over a coverage area; and
wherein at least some of said wireless transceivers have overlapping coverage areas.

49. The system of claim 48, wherein said access controller is configured to select one of said plurality of communication nodes to provide wireless communications to a user device located in an overlapping coverage area.

50. The system of claim 48, wherein said access controller is configured to allocate different frequency channels to at least some wireless transceivers having overlapping coverage areas.

51. The system of claim 48 wherein said access controller is configured to allocate different time slots to at least some wireless transceivers having overlapping coverage areas.

52. The system of claim 48, wherein said access controller is configured to transmit a control message to a second communication node to, at least partially, control the hand-off of a user device that moves from the coverage area of a first wireless transceiver of a first communication node to the coverage area of a second wireless transceiver of said second communication node.

53. The system of claim 42, wherein said access controller is configured to receive information of data traffic of at least some of said plurality of wireless transceivers and to perform load distribution processing based on said information.

54. The system of claim 53, wherein said access controller is configured to re-distribute the load of a plurality of said wireless transceivers by transmitting one or more control messages.

55. The system of claim 42, wherein said wireless transceiver of at least some of said communication nodes is located in a customer premises and coupled to said controller via a low voltage power line.

56. The system of claim 42, wherein the at least one power line includes a medium voltage power line; and
wherein at least one of said plurality of communication nodes further comprises a modem communicatively coupled to said controller and configured to communicate data over the medium voltage power line.

57. The system of claim 42, wherein at least one of said plurality of communication nodes further comprises a modem communicatively coupled to said controller and configured to communicate data over a fiber optic cable.

58. The system of claim 42, wherein said access controller is configured to control at least one communication parameter of one or more user devices by transmitting a control message to said one or more user devices.

59. The system of claim 42, wherein said access controller is configured to perform access control functions for said wireless transceiver of said plurality of communication nodes.
